(19) United States
(12) Patent Application Publication
(10) Pub. No.: US 2026/0148189 A1
(43) Pub. Date: May 28, 2026

(54) Immigration Data Artificial Intelligence

(71) Applicant: William Jose Sanchez, Miami, FL (US)

(72) Inventor: William Jose Sanchez, Miami, FL (US)

(21) Appl. No.: 18/445,932

(22) Filed: Mar. 28, 2024

(51) Int. Cl. G06Q 10/10; G06Q 50/18

(52) U.S. Cl. CPC G06Q 10/10; G06Q 50/18

(57) ABSTRACT

The disclosure is that of a new flutter application using artificial intelligence in order to create an application that makes it easier and more fun to apply for a US immigrant or non immigration visa. The application guides the applicant through the process, and also provides invaluable information which was obtained and developed by the inventor over 30 years of practicing immigration law in the United States. The additional information being provided in the application form includes the types of questions that the person may be asked at the interview, as well as tips for preparation for the interview.

### CROSS-REFERENCE TO RELATED APPLICATION

there has been filed a provisional application with No. 63/577,149 in March, 2023.

### STATEMENT OF FEDERALLY SPONSORED RESEARCH OR DEVELOPMENT

this is not federally sponsored research or development.

### NAMES OF THE PARTIES TO A JOINT RESEARCH AGREEMENT

No, there is not a joint research agreement

There are no discs being submitted in reference to a sequence listing, table, or computer program.

### BACKGROUND ON THE INVENTION

the inventor, has been an immigration lawyer for over 30 years, and approximately 5 years ago, began developing the concepts for an immigration app, that would facilitate Visa applications for foreigners applying for United States Visas through an app on both IOS and Apple.

### BRIEF SUMMARY OF THE INVENTION

The invention is that of an application which assists individuals who want to apply for non immigrant and immigrant visas in the United States. Rather than going through the complicated government process unassisted, this app makes it easy and fun for the person to fill out the form. It is written on google's latest code known as “flutter” and is adaptable to android, and smartphones.

### BRIEF DESCRIPTION OF VIEWS OF THE DRAWING

we are including a number of copies of the screens that are included in the app. There are no separate drawings being submitted.

### DETAILED DESCRIPTION OF THE INVENTION

the invention is written on flutter code, which is a google code that allows for an application to be created for different smartphones; including apple and android phones.

Sequence listing. There is no sequence listing.

1. There are no other patents or inventions that are currently in use in the market. Individuals can apply for a US visa online, through United States government websites, but there is no app which carefully indicates how a person is to fill out a nonimmigrant visa or immigrant visa form.

2. The application is not an improvement on another invention.

3. This application is being made for one claim as previously indicated in number 7,8 and 9 above.
